(19) United States
(12) Patent Application Publication
(10) Pub. No.: US 2010/0330239 A1
(43) Pub. Date: Dec. 30, 2010

(54) METHOD TO STABILIZE LIQUID BETALAINS

(75) Inventors: Pi-Jen TSAI, Pingtung County (TW); Shu-Mien HSIAO, Pingtung County (TW)

Correspondence Address: Muncy, Geissler, Olds & Lowe, PLLC, 4000 Legato Road, Suite 310, FAIRFAX, VA, 22033, US

(73) Assignee: NATIONAL PINGTUNG UNIVERSITY OF SCIENCE & TECHNOLOGY

(21) Appl. No.: 12/823,954

(22) Filed: Jun. 25, 2010

(30) Foreign Application Priority Data
Jun. 26, 2009 (TW) 098121654

(51) Int. Cl. A23L 1/27

(52) U.S. Cl. 426/250

(57) ABSTRACT

A method to stabilize the liquid betalains comprises a flavans step, adding flavans into liquid betalains to obtain a mixture; a heating step, heating up the mixture; and a regenerating step, setting the mixture in a regenerating environment with a temperature of around lower than 25° C. to recover the liquid betalains in the mixture. The recovering betalains are stored under a temperature of 20° C. to 60° C. It is sufficient to maintain the stability of liquid betalains under high water activity or high temperature, also to promote the half-life and stability of betatains.

### BACKGROUND OF THE INVENTION

1. Field of the Invention

The present invention relates to a method to stabilize betalains, particularly to a method to stabilize liquid betalains.

2. Description of the Related Art

According to the fast development of food technology, not only brings about diverse food products to people, also promotes the quality of commercial food products in our life. Nowadays, plenty of food additives are added to food products during the manufacturing process to preserve the flavor or to improve the taste and appearance of food. Among them, food dyes has played a significant role in food industry, which makes manufacturing food more colorful and appetitive especially after long-term of boiling, soaking or drying.

Generally, dyes are usually divided into two kinds, including synthetic dyes and natural dyes. Since the first synthetic dye, mauveine, have first achieved in 1856 by William Henry Perkin, the increasing amount of synthetic dyes have been sequentially developed and applied on food industry. In the twenty century, more than 80 kinds of synthetic dyes are widely used on commercial food products. Nevertheless, it has been reported that most synthetic dyes are poison to animals or human, which may interfere with the normal development of physiology or mental health of biological creatures. As a result, several synthetic dyes have no longer been used under the Pure Food and Drug Act since 1906. Currently, in the USA only the following 9 synthetic dyes are approved of use on food, including FD&C Blue No. 1 (in blue shade); FD&C Blue No. 2 (in dark blue shade); FD&C Green No. 3 (in turquoise shade); FD&C Red No. 40 (in red shade); FD&C Red No. 3 (in pink shade; FD&C Yellow No. 5 (in yellow shade) and FD&C Yellow No. 6 (in orange shade). On the other hand, only 11 kinds of coal tar dyes and 7 kinds of aluminum lake dyes are permitted of use in Japan and only 8 kinds of coal tar dyes and 7 kinds of aluminum lake dyes are approved to be used in Taiwan.

In this situation, due to the safety concern of synthetic dyes, a growing number of natural dyes are being commercially produced to replace the use of synthetic dyes, such as, curcumin, bixin, anthocyanins, β-carotene, riboflavin, canthaxanthin and betalains. Betalains are classes of red and yellow indole-derived pigments usually found in Caryophyllales plants, like beetroots, pitaya, cactus fruits and Taiwan chenopodium. Betalains are water-soluble pigments generally found in the vacuoles of plant cell, which have thought to be related to anthocyanins but show better performance on its utility and application (Herbach et al., 2006b; Stintzing and Carle, 2007). In the U.S., FDA has approved the use of betalains in all food, drugs and cosmetics. It is known that betalains are aromatic indole derivatives synthesized from tyrosine, via the resonating structure of conjugated covalent bond to present red to purple color (Herbach et al., 2006; Stintzing and Carle, 2007). However, the stability of betalains are deeply influenced by complex factors including structure, concentration, light, oxygen, water activity, pH, temperature, ions and some decolorized enzymes (Huang and von Elbe, 1986; Renynoso et al., 1997; Castellar et al., 2003; Herbach et al., 2006b; Herbach et al., 2006c). For liquid betalains, the colors of betalains are no longer to maintain 2 weeks more under the room temperature, which seriously restricted the application of betalains on commercial products.

Due to the less stability of betalains, the utilizations of betalains are limited on food industry. In the conventional study, it may prolong the persistence of betalains by adding some organic acids, citric acid or ascorbic acid for example. It has been reported that 1% of citric acid significantly prolongs the half-life of betalains with 1.5 times of increase (Reynoso et al., 1997; Herbach et al., 2006a). Furthermore, adding 0.003% to 1% of ascorbic acid also can enhance the stability of betalains (Herbach et al., 2006c; Atto and von Elbe, 1985). However, under a high concentration, the stabilization of the organic acids on betalains may not function as that in 0.003% to 1% of organic acids, which will lead to the degradation of pigments (Pasch and von Elbe, 1979), also the spoil favor and test of most food or drugs. Accordingly, it is still ineffectual for adding the organic acids to promote the utility of betalains on food industry.

As a result, although it might be effective for the conventional technique to stabilize the activity of betalains, it shows poor in maintenance the favor and quality of food, as well as the pigment stability of betalains. Hence, there is a need of improving the weakness of conventional technique in order to provide a new method to stabilize the betalains for food industrial use.

### SUMMARY OF THE INVENTION

The primary objective of this invention is to provide a method to stabilize liquid betalains, which can maintain the stability of betalains under high water activity and high temperature.

The secondary objective of this invention is to provide a method to stabilize liquid betalains which can prolong the half-life of betalains.

Another objective of this invention is to provide a method to stabilize liquid betalains which can stability the activity of betalains as storage.

A method to stabilize the betalains comprises a flavans step, adding flavans into liquid betalains to obtain a mixture; a heating step, heating up the mixture; and a regenerating step, setting the mixture in a regenerating environment with a temperature of around lower than 25° C. to recover the pigment of liquid betalains in the mixture.

Further scope of the applicability of the present invention will become apparent from the detailed description given hereinafter. However, it should be understood that the detailed description and specific examples, while indicating preferable embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow chart illustrating the process to stabilize liquid betalains;

FIG. 1A is a chemical formula of the formation of the complex of Schiff base;

FIG. 1B is a LC/Mass spectrometer of the betanin-catechin complex;

FIG. 2 is line charts illustrating the retention rate of betalains with flavans or different phenolic compounds added in different pH and storage times;

FIG. 3 is a bar chart illustrating the half-life of betalains among groups after co-incubating with 0.005M of sulfur dioxide;

FIG. 4 is a bar chart illustrating the half-life of betalains among groups after co-incubating with 0.005M of sulfur dioxide and 0.02M or 0.01M of flavans/phenolic compounds;

FIG. 5 is line charts illustrating the retention rate of betalains as storage at different temperature;

In the various figures of the drawings, the same numerals designate the same or similar parts.

### DETAILED DESCRIPTION OF THE INVENTION

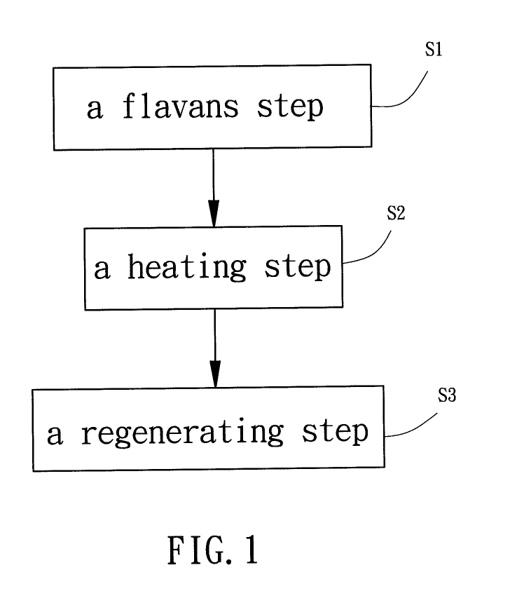

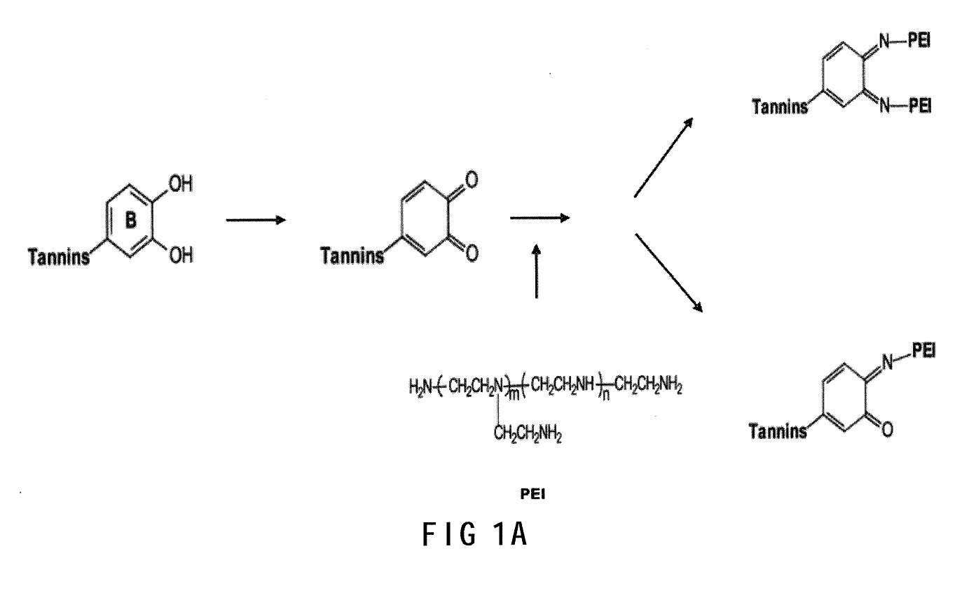

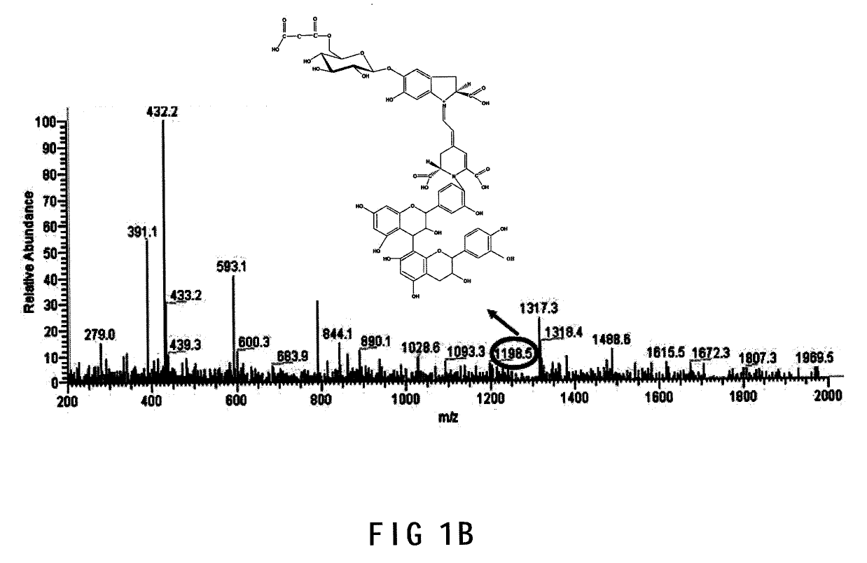

FIG. 1 shows a diagram presented a method to stabilize liquid betalains in the present invention which comprises a flavans step S1, a heating step S2 and a regenerating step S3.

In the flavans step S1, the betalains are extracted from a Caryophyllales plant, such as pitaya and Chenopodium formosanum. In the present invention, the Caryophyllales plant is extracted by 80% of alcohol, following by vacuum condensation and freeze-drying to obtain an extraction of betalains. The extraction of betalains is formulated with 0.02 mM of phosphate buffers consisting of 0.1 M of citric acid and 0.2 M of Na₂HPO4 in pH 2 to 7 to obtain liquid betalains. The liquid betalains are well-mixed and co-incubated with 0.005 M of flavans in a ratio of 1:250 moles at a particular temperature for a period of time, incubating at 25° C. for 1 hour for example. In the present invention the flavans can be a kind of catechins or anthocyanins.

In the heating step S2, mixtures obtained from the flavans step S1 are heated under a particular condition, such as 60° C. to 124° C. for 4 seconds to 2 hours. In the heating period, the betalains in the mixtures may be thermal-degraded to produce betalamic (in yellow) and cyclodopa-5-O-glycoside (in colorless). In general, the degradation of betalains is reversible due to the regeneration of aldimine bond of betalains under a preferring temperature (Hung and von Elbe, 1987; Schwartz and von Elbe 1983; Stintzing and Carle 2004). However, the regenerated pigment of betalains will be unstable, particular at high temperature, and accordingly most betalains may show poor coloring and maintenance after regeneration, especially under long-term preservation. In the heating step S2 of the present invention, the flavans will be oxidized, and then an oxide of flavans, quinone, can interact with the betalains to produce several complexes of Schiff base. With reference to FIG. 1A, the complex of Schiff base is an imine complex derived from an electrophilic addition between the binding of CO— from quinone and N— from betalains. The complex of Schiff base can stabilize the activity of pigment of betalains even under a higher temperature, and prolong the maintenance of betalains after pigment regeneration.

In the regenerating step S3, the mixtures collected from the heating step S2 are kept at a lower temperature (lower than room temperature, preferable to 1° C. to 20° C.) for 4 hours to 15 days for pigment regeneration. In the regeneration step S3, the binding between betalamic and cyclodopa-5-O-glycoside is regenerated under a preferring circumstance, such as 4° C. for 24 hours, so that the pigment of betalains will be performed again. With reference to FIG. 1B, regenerated pigments of betalains, with betanin-catechin complex, may be obtained in the regenerating step S3, which will be more stable and efficient in use.

In example 1, as a preferable example, the liquid betalains are obtained from preparing a formula of an extraction of betalains from peels of pitaya and 0.02 M of phosphate buffer. In the example 1, two set of phosphate buffer are used differentially in pH 4 and pH 6. The liquid betalains are well-mixed and co-incubated with catechin at 25° C. for 1 hour followed by heating at 80° C. for another 1 hour to thermal-degrade the aldimine binding of betalains. Finally, the liquid betalains are kept at 4° C. for 24 hours to regenerate the pigment of betalains. In this way, the liquid betalains extracted from pitaya are obtained.

For further study the pigment stability of the liquid betalains extracted from pitaya in the present invention, six groups of liquid betalains including a control group (control) without adding any flavans or phenolic compounds, a catechin group (A), a coumaric acid group (B), a cinnamic acid group (C), cholorogenic acid group (D) and benzoic acid group (E) are prepared to undergo a serial of test including retention rate, half-life and resistance to sulfur dioxide. Table 1 summarizes the conditions and retention rate of liquid betalains in six groups. In the control group, the liquid betalains without adding and co-incubating with any flavans or phenolic compounds are prepared for differentially going through a process of unheated (I), heated at 80° C. for 1 hour (II) or heated at 80° C. for 1 hour followed by pigment regeneration at 4° C. for 24 hours (III) in order to record the optical density (OD) under wavelength of 538 nm. In the groups (A) to (E), 0.005 mM of catechin, coumaric acid, cinnamic acid, cholorogenic acid and benzoic acid are added into the liquid betalains individually for going through the same process as the control group does.

Table 1 shows the retention rates of liquid betalains in group (A) and group (E) in which a significant higher degree are observed than that in other groups, especially under the treatment of (III).

TABLE 1
the retention rate of liquid betalains in 6 groups
Retention rate (%)

| | | control | (A) | (B) | (C) | (D) | (E) |
|---|---|---|---|---|---|---|---|
| | (I) | 100 | 100 | 100 | 100 | 100 | 100 |
| pH 4 | (II) | 37.06 | 41.17 | 38.58 | 38.95 | 38.31 | 43.39 |
| | (III) | 48.04 | 51.52 | 48.98 | 48.72 | 42.52 | 51.81 |
| pH 6 | (II) | 30.43 | 40.73 | 34.20 | 35.65 | 33.50 | 40.65 |
| | (III) | 40.78 | 49.19 | 42.04 | 38.72 | 34.01 | 46.56 |

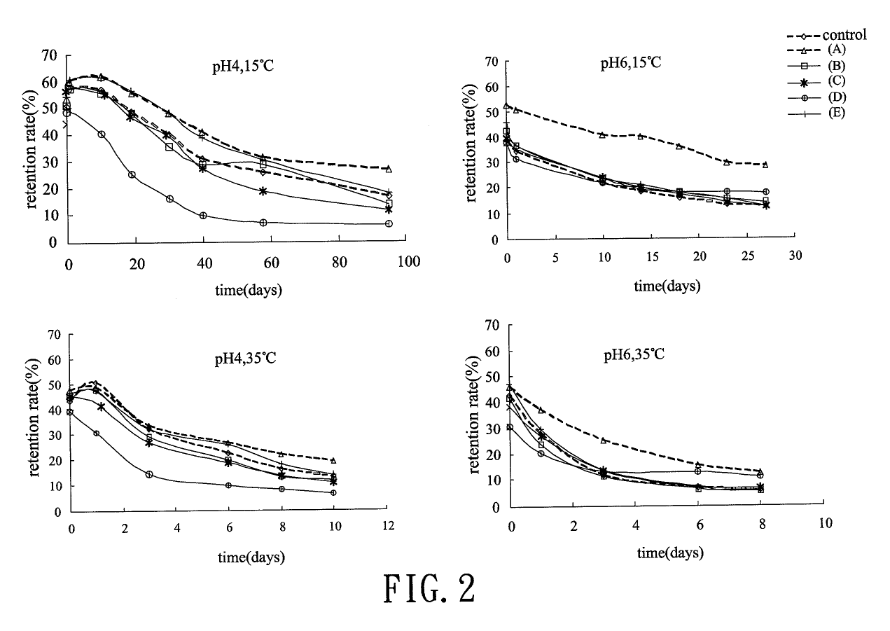

FIG. 2 illustrates the change of retention rate of each group after storing at 15° C. or 35° C. for 10 to 100 days, wherein the retention rate of each group is decreased by days. However, in group (A), the retention rate is still maintain at 30% as storage at 15° C. whatever under pH 4 or 6, at 1320% as storage at 35° C. under pH 4 or pH 6 for more than 10 days. Therefore, it is suggested that adding catechin into liquid betalains is sufficient to enhance the stability of pigment of betalains as storage.

Table 2 summarizes the half-life (t_{1/2}) of the control group, (A), (B), (C), (D) and (E) after storing at 15° C. or 35° C., wherein the group (A) shows significant longer half-life, around 93.3 days in pH 4 15° C., 7.12 days in pH 4 35° C., 25.66 days in pH 6 15° C. and 3.66 days in pH 6 35° C., than that in other groups. Therefore, it is believed that adding catechins into liquid betalains is beneficial to prolong the half-life of betalains as storage.

TABLE 2
Half-life of betalains in each group
Half-life (t_{1/2}; days)

| | | Groups | | | | | |
|---|---|---|---|---|---|---|---|
| Temp. | | Control | (A) | (B) | (C) | (D) | (E) |
| pH 4 | 15° C. | 59.48 | 93.30 | 65.21 | 44.71 | 22.76 | 67.39 |
| | 35° C. | 6.18 | 7.12 | 5.43 | 5.01 | 2.34 | 6.60 |
| pH 6 | 15° C. | 12.80 | 25.66 | 11.85 | 14.20 | 3.07 | 11.01 |
| | 35° C. | 1.79 | 3.66 | 1.48 | 2.16 | 1.50 | 1.74 |

According to the results shown in the test of retention rate and half-life, the liquid betalains obtained via the method to stabilize liquid betalains in the present invention perform dramatically well in pigment stability and maintenance, especially under a circumstance of pH 4 at 15° C.

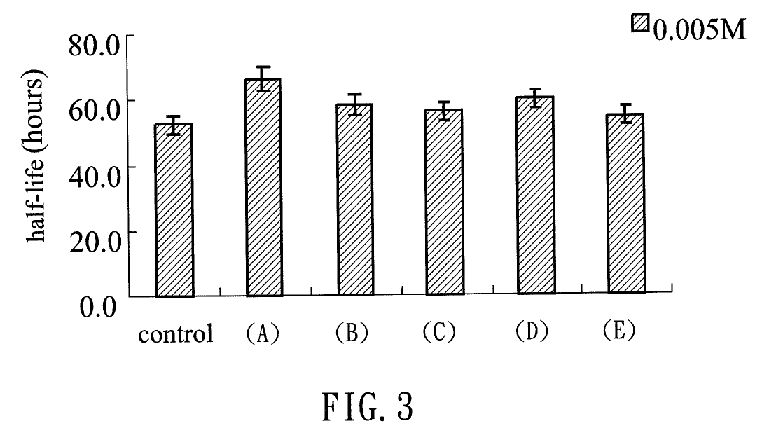

FIG. 3 summarizes the half-life (t_{1/2}) of the control, (A), (B), (C), (D) and (E) groups after co-incubating with 0.005M of sulfur dioxide at 25° C. It has been know that the sulfur dioxide may fade the color of anthocyanins. Generally, as co-incubation with 500 to 2000 ppm of sulfur dioxide, some colorless products may produce and lead to the pigment fading in fruits or vegetables.

As shown in the FIG. 3, half-life (t½; hours) in the groups (A) to (E) are significantly higher than that in the control group. It seems that adding flavans into liquid betalains is beneficial to extend the half-life of betalains, also enhance the resistance to sulfur dioxide. Among groups, the group (A) reveals better performance on half-life with approximately 66.47 hours which is much longer than 59.94 hours of group (D) and 56.6 hours of group (E).

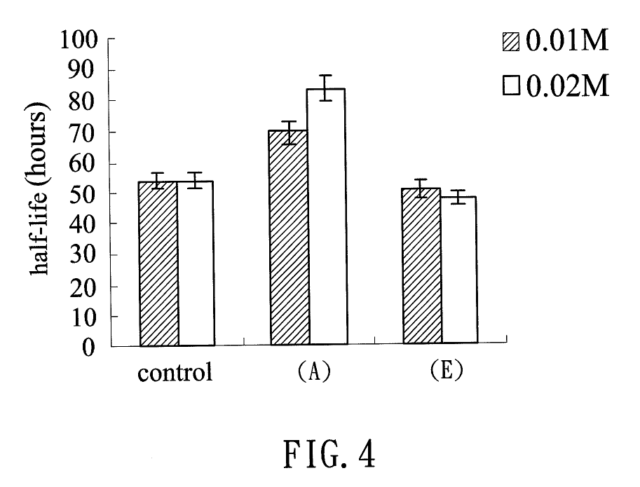

Furthermore, FIG. 4 shows the relation between the half-life (t½; hours) of betalains and adding concentration of catechin or benzoic acid among groups, wherein the half-life of the betalains shows positive dose-dependent on catechin, but negative dose-dependent on benzoic acid. As summarized in FIG. 4, the half-life of the betalains is 50.86 and 47.75 hours individually as co-incubation with 0.01M or 0.02M of benzoic acid. On the other hand, the half-life of the betalains go up in accord with the increase of adding concentration of catechin, which is 69.51 hours as co-incubation with 0.01M of catechin and 83.51 hours as co-incubation with 0.02M of catechin. As a result, adding higher concentration of catechin is effective to prolong the half-life of the betalains. Additionally, the method to stabilize liquid betalains in the present invention positively shows great effects on promoting the stability and half-life of betalains.

In example 2, as a preferable example, the liquid betalains are obtained from the formula of an extraction of betalains from Chenopodium formosanum and 0.02 M of phosphate buffer. In the example 2, phosphate buffers in pH 4 and pH 6 are differentially used to prepare the liquid betalains. The liquid betalains are well-mixed and co-incubated with anthocyanins at 4° C. for 24 hours followed by heating at 85° C. for 20 minutes to thermal-degrade the aldimine binding of betalains. Finally, the liquid betalains are kept at 4° C. for 24 hours to regenerate pigments of betalains.

Similar to the example 1, for studying the pigment stability of the liquid betalains extracted from Chenopodium formosanum in the present invention, three groups of liquid betalains including a group (a), liquid betalains added with anthocyanin from mulberry; a group (b), the same liquid betalains as group (a) with 0.1% of citric acid, 6% of sucrose and 0.2% of CMC; and a group (c), liquid betalains obtained from similar process but dissolved in water.

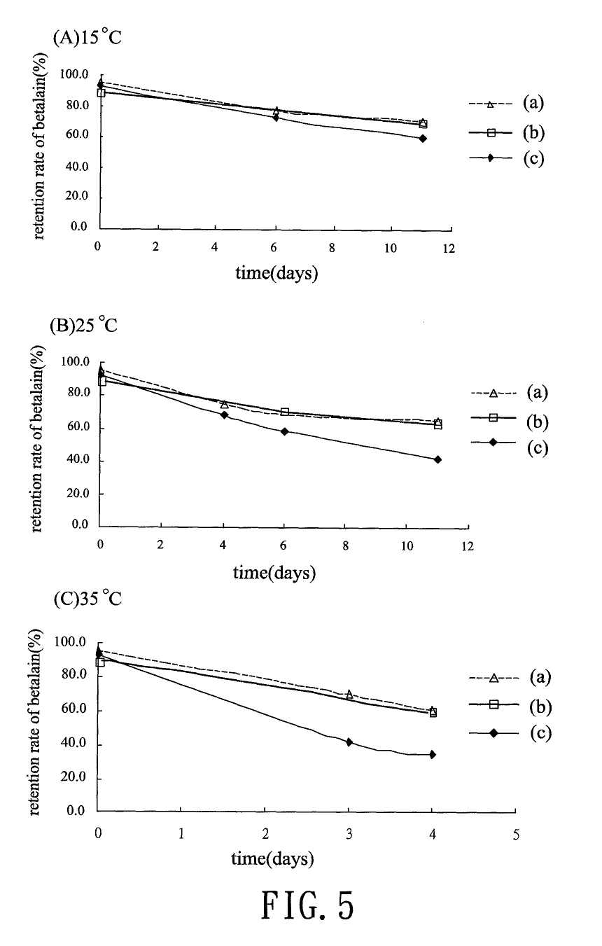

FIG. 5 summarizes the pigment retention rate in group (a) to (c) after storing at 15° C., 25° C. and 35° C., wherein the group (a) and (b) shows better retention rate than that in group (c) whatever as storage at 15° C., 25° C. and 35° C. In group (a), (b) and (c), the retention rate is 70.88%, 69.41% and 60.33% at 15° C., but 60.96%, 60.19% and 34.91% at 35° C. separately. It seems that the retention rate in group (a) and (b) are significant higher than that in group (C), especially under higher storing temperature. It suggests that adding anthocyanins to liquid betalains is sufficient to maintain the stability of pigment of betalains as storage.

Table 3 lists the half-life of the group (a) to (c) after storing at 15° C., 25° C. and 35° C., wherein the half-life (t_{1/2}; days) of the group (a) and (b) are longer than that in the group (c). According to the Table 3, the half-life of group (a) and (b) is 39.40 and 38.58 days at 15° C.; 28.92 and 28.58 days at 25° C.; and 5.93 and 5.79 days at 35° C. all higher than that in group (c), which shows only 17.26 days at 15° C.; 10.12 days at 25° C.; and 2.85 days at 35° C. Hence, due to the results shown in the test of pigment stability it is believed that the method to stabilize liquid betalains in the present invention does have great influence on pigment stability of liquid betalains even suffering from thermal degradation or long-term storage.

TABLE 3
Half-life of betalains in group (a), (b) and (c)
Half-life (t_{1/2}; days)

| Temp. | (a) | (b) | (c) |
|---|---|---|---|
| 15□ | 39.40 | 38.58 | 17.26 |
| 25□ | 28.92 | 28.58 | 10.12 |
| 35□ | 5.93 | 5.79 | 2.85 |

In summary, according to the results obtained from pigment stability study (including the test of retention rate, half-life and resistance to sulfur dioxide) it is shown that adding flavans is beneficial to promote the stability of pigment of liquid betalains. In the present invention, it has been demonstrated that flavans will interact with betalains in liquid, and accordingly several complex of flavans-betalains may obtained after the heating and regenerating step. It has been further examined via HPLC and LC/MS analysis that complex of flavans-betalains derived from the interaction of the flavans and betalains in the heating and regenerating step will positively regulate the pigment stability of betalains in a dose-depended manner.

Through the present invention, via the method for stabilizing liquid betalains strongly stabilize the pigment of betalains even under high water activity or high temperature. Moreover, via the method for stabilizing liquid betalains in the present invention, adding flavans in liquid betalains prolong the half-life of betalains, and also enhance the storage stability of betalains after treatment of sterilization.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A method to stabilize liquid betalains, comprising:
a flavans step, adding flavans into liquid betalains to obtain a mixture;
a heating step, heating up the mixture; and
a regenerating step, setting the mixture in a regenerating environment with a temperature of lower than 25° C. to regenerate the pigment of betalains in the mixture.

2. The method to stabilize liquid betalains, as defined in claim 1, wherein a selecting step is performed to choose catechins as the flavans before the flavans step.

3. The method to stabilize liquid betalains, as defined in claim 1, wherein a selecting step is performed to choose anthocyanins as the flavans before the flavans step.

4. The method to stabilize liquid betalains, as defined in claim 1, wherein a formulating step is performed to prepare the liquid betalains with diverse pH from 2 to 7 before the flavans step.

5. The method to stabilize liquid betalains, as defined in claim 1, wherein the heating step is under a circumstance of 60° C. to 124° C.

6. The method to stabilize liquid betalains, as defined in claim 1, wherein the heating step the mixture is heated up for 4 seconds to 2 hours.

7. The method to stabilize liquid betalains, as defined in claim 1, wherein the regenerating step, the temperature of the regenerating environment is 1° C. to 20° C.

8. The method to stabilize liquid betalains, as defined in claim 1, wherein the regenerating step the mixture is kept in the regenerating environment for 4 hours to 15 days.
